(19) United States
(12) Patent Application Publication
(10) Pub. No.: US 2009/0127745 A1
(43) Pub. Date: May 21, 2009

(54) Device for Producing, by Moulding, a Casing with Bellows Including Means for Holding an Unscrewable Core and Corresponding Method

(76) Inventors: Bernard Renzo, Laval (FR); Pascal Tournier, Saint Germain Le Fouilloux (FR)

Correspondence Address: THOMAS, KAYDEN, HORSTEMEYER & RISLEY, LLP, 600 GALLERIA PARKWAY, S.E., STE 1500, ATLANTA, GA, 30339-5994, US

(21) Appl. No.: 11/718,271

(22) PCT Filed: Nov. 3, 2005
(86) PCT No.: PCT/EP05/55721

§ 371 Date: Dec. 12, 2008

(30) Foreign Application Priority Data
Nov. 3, 2004 (FR) 0411732

(51) Int. Cl. B29C 41/42

(52) U.S. Cl. 264/334; 425/556

(57) ABSTRACT

The invention relates to a device for producing, by molding, a casing (3) having at least one helical bellows, comprising a mold (2) constituted of indentations and of at least one core (1) each having a helical threading complementary to one another whereby delimiting a molding space. Said device comprises means that make it possible to carry out an unscrewing relative to the casing (3) and to said core (1) in order to proceed with removing the casing from the mold. The invention is characterized in that it comprises means (51, 6) for holding each of the ends of the core (1) during molding, this core (1) having a helix angle of less than approximately 15°.

The field of the invention is that of techniques for moulding hollow objects. More specifically, the invention relates to the moulding of a helical casing with bellows.

Such parts with bellows are used for various applications, which parts can in particular be implemented as a protective element for an extensible or flexible coupling device, as a flexible sheath for protecting cables (or the like) or as a casing containing a liquid.

The bellows of these casings conventionally comprise turns that extend radially, allowing for radial, axial and angular movements of the protected device.

To improve the performance of these bellows, and in particular their lifetime, they are made of a thermoplastic elastomer. This type of material makes it possible moreover to obtain low production cycle times and therefore a moderate cost. However, the bellows constituted by such materials cannot be forcefully unmoulded without being damaged. This is why casings with bellows are generally produced by an extrusion blow moulding or an injection blow moulding process, in which there is no unmoulding problem. These methods are costly and do not make it possible to obtain a production quality satisfying the current requirements, because the thickness of the walls is not controlled with adequate precision.

Another solution has therefore been proposed, consisting of producing casings with bellows by injection.

The thickness is thus ensured by the cavity and the core of the mould of the part.

However, the unmoulding thereof requires that they be deformed, in particular by inflating them with compressed air so as to release the turns from the core, and by pulling them from the core (with the mould having been previously opened).

Such an unmoulding mode is fairly suitable for bellows made of a vulcanised elastomer, a material that handles very large deformations and that returns to its moulding shape after unmoulding.

However, this type of unmoulding causes excessive stress for thermoplastic elastomers, which tends to cause them to give, or weakens them and adversely affects the lifetime of the bellows.

Still another method for producing casings with bellows having radial bellows with large undercuts was proposed in the prior art.

This process consists of moulding the parts by single or multi-cavity injection, then unmoulding the bellow-shaped parts by relative unscrewing of the core with respect to the part.

This new mode of production of bellows involves a very specific bellows shape. Indeed, the turns are helical so as to allow for the unscrewing of the core or the part.

Nevertheless, the helical turns cause disturbing reactions in production, and even on the behaviour of the parts.

Indeed, in production, the relative unscrewing of the core with respect to the bellows causes a problem: the friction between the core and the bellows. As the material is hot during the unmoulding, the friction coefficient is relatively high, while the elastic modulus is lower. The bellows can therefore be deformed by twisting of the turns by applying the unscrewing torque.

There are numerous solutions for obtaining a low friction coefficient:
choosing a bellows material with a low friction coefficient, but this limits the choice of materials and requires the use of specific, expensive materials or materials weakened by antifriction adjuvants;
applying an antifriction surface treatment on the core, but this type of treatment deteriorates with use. Indeed, for high-rate mass production, the core is therefore subjected to a large number of unmouldings, which requires regular maintenance and involves corresponding costs. This solution is therefore unsatisfactory alone for economic reasons;
injecting a fluid at the core/bellows interface in order to reduce the friction. It is indeed possible to separate the bellows with compressed air and to thus easily unscrew the core.

The implementation of this last technique (injection) nevertheless causes a problem: it is necessary to obtain a good airtight seal at the ends of the bellows in order to be capable of separating the walls of the bellows from the surface of the core.

This airtightness is not easy to guarantee, and if there is a leak, some parts may remain stuck to the core. This leads to production shutdowns in order to undo the non-unmoulded parts.

Another solution has been proposed, consisting of moulding the bellows with a base. The airtightness is thus automatically ensured at this end and the bellows separates well.

However, for bellows such as cable guides or protectors for flexible mechanisms, it is necessary to have the two ends of the bellows open. Thus, it is necessary to apply an additional operation of cutting the base of the bellows and causes material to fall, which increases the cost of producing the part.

Another problem occurs: under the injection pressure, the core bends slightly, which can cause geometric defects with a poor distribution of thickness.

The invention aims in particular to mitigate the disadvantages of the prior art.

More specifically, the invention aims to propose a device for moulding a casing with helical bellows, of the type involving the relative unscrewing of the casing and a core during unmoulding, which is more reliable than those of the prior art.

In this sense, the invention aims to provide such a device which enables the parts to be moulded with high precision, thereby limiting the risks of deformation during unmoulding.

The invention also aims to provide such a device which is simple in design and inexpensive to implement.

These objectives, as well as others that will become apparent below, are achieved by the invention, the object of which is a device for producing, by moulding, a casing having at least one helical bellows, of the type including a mould consisting of cavities and at least one core, each having a helical threading complementary to one another so as to define a moulding space, said device including means making it possible to cause a relative unscrewing of said casing and said core in order to carry out the unmoulding of said casing, characterised in that it includes means for holding each of the ends of said core during the moulding, said core having a helix angle smaller than around 15°.

In this way, a device is obtained that makes it possible to anticipate the production of parts with high precision owing to the perfect holding of the core inside the mould, which precision is in no way diminished during unmoulding, owing to the optimised helix angle of the core, which ensures proper unscrewing of the core and the casing, while limiting the risks of excessive friction that would be capable of causing a deformation of the casing.

Moreover, the Applicant has noted, as concerns the part thus produced, that a helical turn tends to substantially improve the behaviour of the casing when its helix angle is less than 15°.

A helix angle selected according to the invention therefore makes it possible to limit the crushing of the material during the unmoulding by unscrewing.

A helix angle that is too small does not allow for high turn elasticity, in particular during compression, because the sides of the turns are too close together. Conversely, a helix angle that is too large involves a distortion of the compressed bellows and causes high torque at its ends.

It is noted that it is suitable for said helical threading of said cavities also has a helix angle smaller than approximately 15° and, optimally, that it corresponds to the helical threading of said core so as to facilitate the flow of material during injection.

According to an advantageous solution, said threadings of said core and said cavities have a helix angle of between 2° and 7°.

This makes it possible to obtain a casing with bellows of which the characteristics are further optimised.

Preferably, said core has a frusto-conical shape, with a coning angle greater than or equal to 1°.

It is advantageous in particular for relatively long bellows (cable guide, dampening, steering, tubing, transmission bellows) to apply a taper to the core, preferably greater than or equal to 1°. This makes it possible to unscrew the core without causing friction of the bellows over the entire length of the core.

In this way, during the unscrewing according to another advantageous characteristic, said threadings of said core and said mould are provided so that said moulding space has a decreasing cross-section in a direction opposite the unmoulding direction.

This makes it possible to facilitate the unmoulding, because only the separation is necessary, then no friction persists between the core and the turns during the continued unscrewing of the core.

Advantageously, at least one turn of said threads of said mould and said core has a pitch ranging between around 10% and around 40% of the average apparent diameter of said turn, and preferably between 13% and 30%.

A large pitch can cause a problem of crushing of the material during the unscrewing of the core, and a small pitch requires more unscrewing rotations and therefore a longer unmoulding time, adversely affecting the production cycle time. In addition, a pitch that is too large with respect to the size of the bellows causes problems of instability and a high torque at the ends.

This is avoided by using a pitch within the size ratios indicated above.

According to one advantageous solution, at least one turn of said threadings of said mould and said core has a depth ranges between around 0.5 times and around 3 times the pitch of said turn, and preferably between 0.7 times and 1.8 times. This makes it possible to obtain a better unscrewing of the core.

In addition, in order for a helical turn to work under proper conditions, it is preferable to have a turn height that is at least greater than half of the turn pitch.

Indeed, the helix is stiffer as the sides are less axially inclined, and therefore as the height is lower. In addition, the longitudinal stresses in the turn are greater when the height is low.

Finally, unlike with axisymmetrical turns, a high turn height is not favourable, because the instability effects increase. This height must therefore remain lower than 3 times the pitch.

According to another characteristic, said turn(s) of said threading of said mould have a side including at least one straight portion inclined with respect to a straight line perpendicular to the longitudinal axis of said mould with an angle greater than or equal to the helix angle of said turn(s).

In this way, the undercut in the cavity of the mould is limited, owing to the turn sides inclined at an angle that is at least greater than the helix angle. Otherwise, the extraction of the bellow from its cavities is more difficult during unmoulding.

According to one particular embodiment, at least one turn of said threading of said mould has a side including at least two portions of different shapes.

Owing to the undulations on the turn sides, there is greater flexibility in particular when pulling the bellows. Indeed, the sides have a greater folded length. In addition, the undulations enable the turn sides to work more.

In this case, said portions of said side preferably have, on each side of a common area, tangents forming an angle of around 15° between them, each of said tangents forming an angle of at least 20° with the longitudinal axis of said mould.

Indeed, the junction between two side portions should not represent an accentuated break angle, a source of stress concentration. Either this angle is limited (less than or equal to 15°) or the junction is produced by a curved surface. In addition, it is preferable not to have a portion that is too aligned in the axis of the helix, at the risk of ending up with an excessively rigid arrangement and of reducing the range of movement of the bellows.

Advantageously, said threadings of said core and said mould have a constant pitch.

In this way, it is possible to unmould the bellows by unscrewing the core before opening the mould, with the bellows being held in its cavities. Thus, it is not necessary to have a manipulator robot to take the bellows and unscrew it from the core after opening the mould. A simple alleviation of the force for closing the mould, or a slight opening of the mould by a few hundredths to a few tenths of a millimetre can be allowed in order to reduce the pressure exerted on the material of the bellows and on the core.

Finally, it is advantageous to have an area with a larger cross-section that makes it possible to more quickly supply the areas to be filled in the mould that are farthest from the injection point, during moulding of the part. This promotes the filling of the mould for parts with a low thickness. It is preferable for this area to follow the helix by forming a helical channel.

The ridges can also have an increased thickness in order to promote the injection of plastic material during production.

Said threadings of said core and said mould are preferably provided so that said casing has turns of which the thickness at the level of the grooves is greater than or equal to the thickness of the sides.

Thus, the area of the helix forming the groove of the turns of the bellows is a bit larger and stronger.

Another effect is that of correcting the distortion due to the deformation of helices of the grooves and ridges of the turns. This effect is thus obtained by increasing the rigidity of the bellows' turn groove helix.

According to another characteristic, said threadings of said core and said mould are provided so that said casing has a thickness that increases as the diameter of the cone frustum of said core decreases.

A greater thickness such as this, for turns having a smaller diameter, which are closer to the apex of the helix, makes it possible to at least partially compensate for the reduction in the cross-section.

This thus makes it possible to improve the conditions of injection of the part during production and to better distribute the stresses when the bellows is compressed. It is noted that it is preferable for the thickness of the turn to increase continuously as the radius (of the helix) of the turns decreases.

According to an advantageous alternative, said threadings of said core and said mould have, over at least one portion of their length, at least two helical threadings.

It is thus possible to achieve faster unscrewing of the core, as the helix pitch is greater.

Moreover, the stresses at the ends of the bellows are better distributed.

In this case, said helical threadings preferably have a helix angle between around 2.5° and around 15°.

According to a preferred embodiment, said mould has means for holding said casing during said relative unscrewing of said casing and said core. In this case, it is preferable to have holding means on each side of the threading.

Due to the thermal stress associated with the shrinkage of the material after the injection of plastic into the mould, the bellows holds to the core. When the core is unscrewed so as to unmould the bellows, the turns tend to stick to the core. The torque applied can cause buckling of the bellows and even damage thereto, in particular for long ones.

This is why it is preferable to have, at a few locations on the bellows, means for holding the turns in the mould, which thus prevent the turns from following the movement of the core during the unscrewing operation.

According to one advantageous embodiment, said holding means include at least one groove intended to form a projecting edge or a rib on said casing.

For long bellows or bellows made of highly flexible material, it is advisable to produce at least one holding means on the threading of said mould, ideally on each of the turns. They are preferably placed on said threading of said mould so as to correspond with the ridges of said bellows of said casing.

Said groove or grooves preferably have a depth of between 0.015 and 5 mm.

According to a preferred solution, said means for holding the core include, at the end of said core first extracted from the mould during the unscrewing of the core, a cylindrical support (bore), and, at its other end, a frusto-conical support.

It is noted that the axial and/or rotational blocking of the core is ensured by a removable stop or by the system for driving the core.

The cylindrical support also guides the core during the unscrewing thereof.

According to another embodiment, the means for holding the core consist of at least one flat portion and one wedge formed at each end of the core. The positioning of the core is obtained by closing the mould elements, which have shapes corresponding to these flat portions and wedges. For the unscrewing of the core, these elements for holding the core are first opened. However, this solution is more complex. In addition, it requires high precision in the production of the equipment, or else the connection of the core with its driving device by means of flexible elements, which can cause some chattering during the unscrewing of the core.

Said mould also advantageously has a frusto-conical shape the taper of which is less than that of said frusto-conical shape of said core.

In this way, during the unscrewing of the core, the bellows is locked in the mould cavities, owing to the positive taper of the latter.

According to another characteristic of the invention, said means for holding said core include means for centring and/or blocking said core with respect to said cavities, forming a stop for the core and a block for positioning it, coming into contact with a bearing surface of the core (a wedge, a cone or a cone frustum), preferably substantially perpendicular to the longitudinal axis of the core and on either transverse side of the core.

Indeed, when the material is injected, pressure (which can reach several tons) is exerted on the core and has a tendency to deform the core and its driving mechanism, which axially offsets the core with respect to the cavities. The deformations are small, but affect a relatively significant length of the kinematic chain, which ultimately causes a resulting movement of the moulding portion of the core. These phenomena can cause the thickness of the turns of the casing to no longer be constant. Such being the case, as concerns the product, a weaker turn wall can result in a fragile area. Simultaneously, inside the moulding, an improper centring of the core causes load losses during the injection and, consequently, an increase in the injection pressure, which is undesirable. Finally, after cooling of the bellows, the unscrewing of the core is more difficult because the unscrewing torque is increased by the pressure caused by the retracted core, which hinders the entire core driving mechanism.

Holding means ensuring the centring and/or the blocking of the core therefore make it possible to avoid these disturbing phenomena and, therefore, to obtain a high-quality product and to ensure a successful production process.

Such means make it possible to lock the core in a specific position with respect to said cavities, in the closed position, and they are moved away from the core for the unmoulding.

According to a preferred solution, said centring and/or blocking means include at least one housing, or rib or pin capable of being moved toward/away from said core, said housing(s) forming means for centring and/or blocking said core in a specific position with respect to said cavities.

Advantageously, said centring and/or blocking means are actuated by a cam system with an inclined ramp.

In this case, said cam system with an inclined ramp is preferably designed so as to convert a drive movement acting in a first direction with respect to said core, into a movement of displacement of said housing(s) in a second direction substantially perpendicular to said first direction.

In this way, it is possible to actuate a plurality of centring means in line with common actuation means, as will become clear below.

It is noted that, according to other possible embodiments, said centring and/or blocking means can also be actuated differently, for example by a cam system or directly by an actuator.

According to an advantageous solution, said housing(s) are inserted into a part bearing a lug capable of sliding into a ramp provided in a drive member.

According to another characteristic of the invention, said core is positioned so that it is offset with respect to said cavities, before injection, so that it tends to be re-centred in said cavities upon a thrust caused by an injection of material into said mould.

The use of centring and/or blocking means then ensure this forward positioning of the core.

According to another advantageous characteristic of the invention, said holding means include at least one additional core in line with said core.

In this case, according to an alternative embodiment, said additional core is inclined with respect to said core.

According to yet another advantageous characteristic of the invention, the device includes a channel for injecting pressurized air between said core and said casing.

The invention also relates to a unit for producing, by moulding, casings including at least two devices of the type each including a mould consisting of cavities and at least one core each having a helical threading, complementary to one another so as to define a moulding space, said device including means making it possible to cause a relative unscrewing of said casing and said core so as to carry out the unmoulding of said casing, characterised in that said devices each include holding means, for each of the ends of said core during moulding, said core having a helix angle smaller than around 15°.

Said holding means of each core advantageously include means for centring and/or blocking said core with respect to said cavities.

Preferably, said means for holding said core of at least two of said devices are driven by common actuation means.

The invention also relates to a method for producing a casing having at least one helical bellows, including a moulding step performed with a production device including a mould and at least one core each having a helical threading complementary to one another so as to define a moulding space, said device including means for causing a relative unscrewing of said casing and said core so as to carry out the unmoulding of said casing, characterised in that said moulding step is performed using a core with a helix angle smaller than around 15°, said core being held at each of its ends during said moulding step.

The core is preferably carefully guided at least at one of its ends throughout the entire unscrewing thereof.

According to another aspect of the invention, the injection of plastic material is performed at one or more points of the casing, not in a sheet. The mode of sheet injection at the apex of the bellows is known. It makes it possible to prevent a weld line of the material during moulding. However, it is necessary to cut this portion after unmoulding, which results in additional costs for cutting and regrinding of the waste material. The single or multipoint injection proposed is carried out on at least one end of the bellows or on one of these turns (on a ridge), at high speed. This makes it possible to obtain the desired finished geometry without any additional operation and to obtain a high-quality weld line. Indeed, the melt fronts merge at a high enough temperature owing to the spontaneous heating of the material by viscous dissipations generated as it flows into the mould, into the confining space between the core and the cavities.

According to alternative embodiment, the method includes a step of injecting fibre-reinforced material.

This method is particularly suitable for the injection of fibre-reinforced materials and their orientation within the part. Indeed, during the injection, the flow of material circulating in the equipment has a preferably helical path, which makes it possible to give the fibres an orientation so as to reinforce the part without thereby adversely affecting the flexibility thereof.

Other characteristics and advantages of the invention will become more apparent from the following description of a preferred embodiment of the invention, given by way of an illustrative and non-limiting example, and from the drawings, in which:

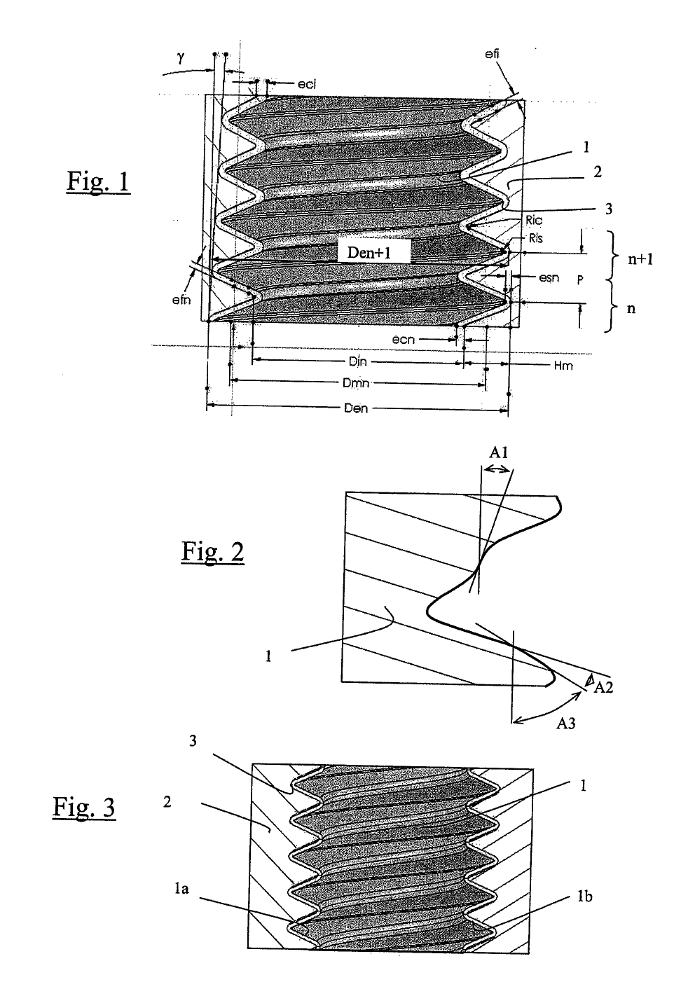

FIG. 1 is a partial view of a core arranged in its mould, of a device for producing a casing with bellows according to a first embodiment of the invention;

FIG. 2 is a partial view of a core of a device for producing a casing with bellows according to a second embodiment of the invention;

FIG. 3 is a partial view of a core arranged in its mould, of a device for producing a casing with bellows according to a third embodiment of the invention;

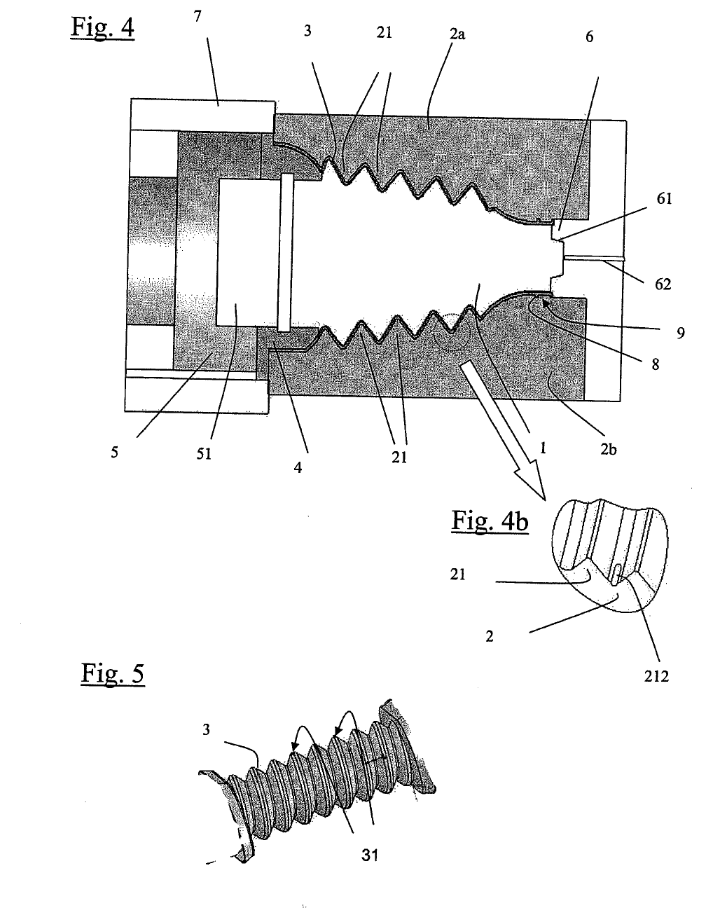

FIG. 4 is a cross-section view of a device for producing a casing with bellows according to the invention;

FIG. 5 is a perspective view of a casing with bellows obtained using a device according to the invention;

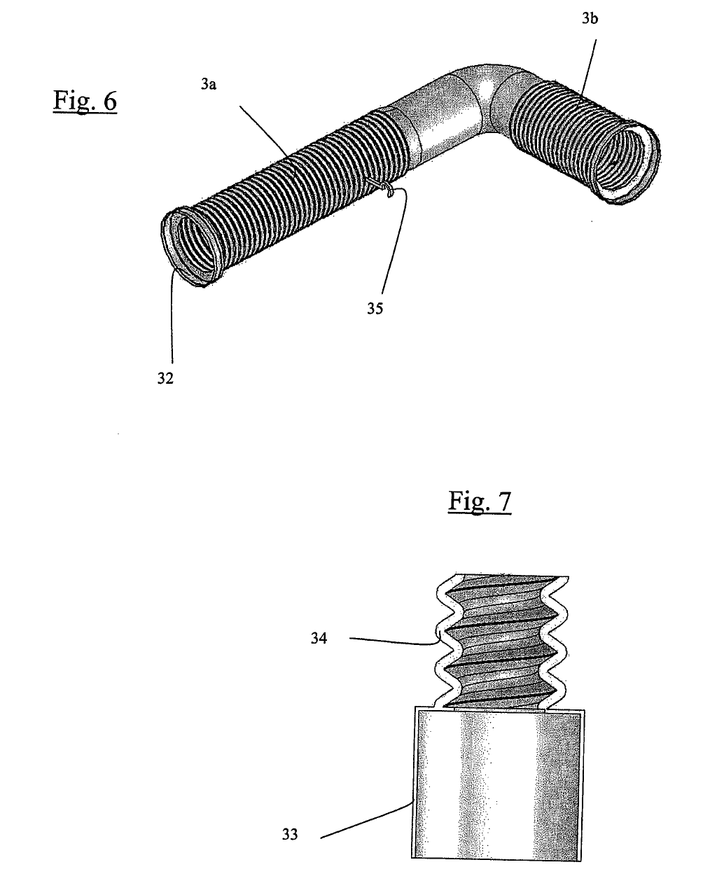

FIGS. 6 to 7 show applications of casings with bellows obtained with a production device according to the invention;

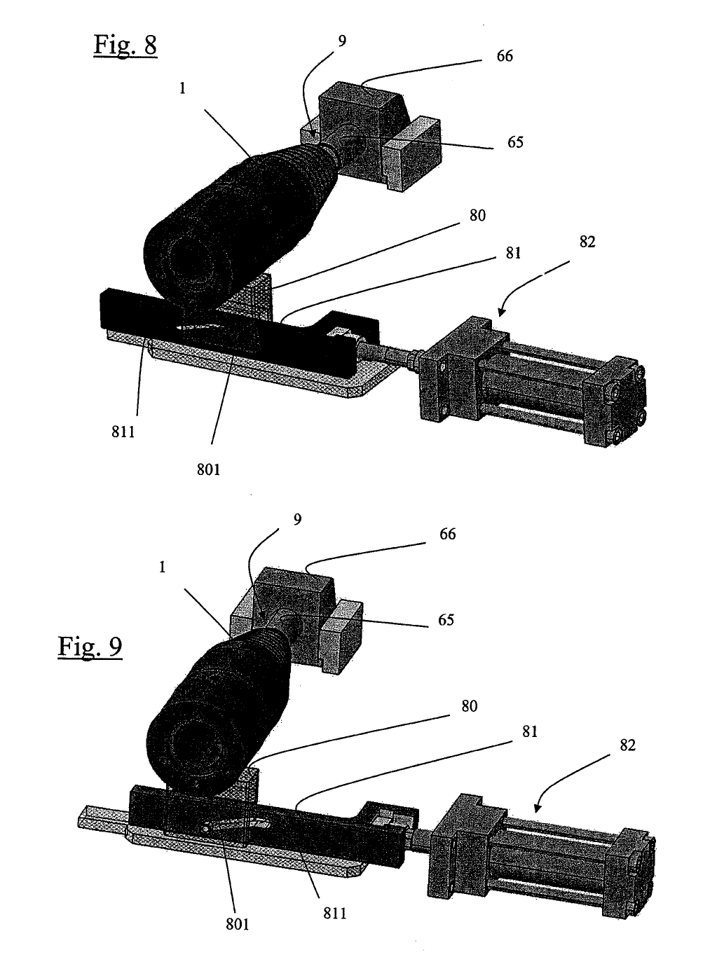

FIGS. 8 and 9 are views of a specific embodiment of means for holding the core, in the position for blocking and in the position removed from the core, respectively;

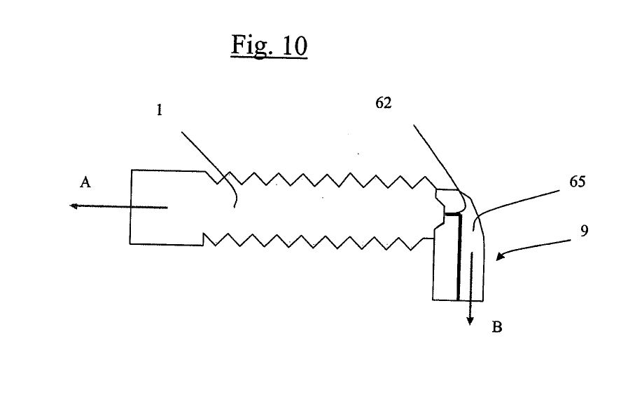

FIG. 10 shows the case of a means for holding the core by an additional perpendicular core.

A device for producing a bellows according to the invention is shown in FIG. 4.

According to this embodiment, such a device includes at least two cavities 2 and one core 1. As shown, a second core 4 makes it possible to mould a non-cylindrical internal shape for the large base of the casing with bellows. The geometry of the casing with bellows 3 is determined by cavities 2 and the cores 1, 4. During the unmoulding, the casing with bellows is held inside the cavities 2 and the core 1 is unscrewed. It rotates inside the second core 4, and the two cores 1, 4 retract into a support portion 7 of the equipment, by means of the element 5, so as to release the casing with bellows. Then the mould is opened so as to eject the part.

According to a first aspect of the invention, such a production device includes means for holding each of the ends of the core 1 during moulding.

These holding means include:
a bore 51 ensuring the centring of the core in the support 7 of the mould, via the element 5 ensuring the rotation and the translation of the core (screwing/ unscrewing movement) (it is noted that the element 5 and the core 1 can be formed by a single part, with the bore 51 capable of coming to bear directly against the support 7 of the mould according to an alternative design);
a cone 6, ensuring the holding of the core at the end thereof, opposite the element 5 (frusto-conical portion 61 of the end piece 6).

According to another aspect of the invention, the core 1 has a helix angle smaller than 15° and preferably between 2° and 6°.

The casing 3 is held in the mould 2 during the unscrewing of the core 1 by means of its non-symmetrical portion on the side of the large base thereof and with lugs 8 at the other end thereof.

The screwing/unscrewing movement of the core 1 is ensured by a gear mechanism.

In reference to FIG. 1, the following parameters are defined.

The mean diameter Dmn of a turn n is named as being the mean of the diameter of the exterior spiral representing the ridge of the turn Den and of the diameter of the internal spiral representing the inside diameter of the groove of the turn Din. When a bellows is observed, it is not always possible to measure the inside diameter of the turn Din without being required to cut it. This is why another parameter is defined: the mean apparent diameter of a turn Dman determined by the mean of the outside diameter Den and of the outside diameter of the groove of the turn, Dicn.

For low wall thicknesses, as is the case of bellows in general, and very specifically those designed according to the invention, Dman is close to Dmn.

The turn pitch P corresponds to the distance between two turn ridges or two turn grooves. It is preferable to measure the pitch between two turn ridges n and n+1.

The helix angle αn of a turn is determined by the arc tangent of the ratio of the pitch P to the mean exterior perimeter of the turn π Dmen, that is:
αn=arc tan (P/π. Dmen)) with Dmen=(Den+Den+1)/2,
with Den+1 being the outside diameter of the turn n+1.

The height of a turn Hn is chosen to be equal to the difference between the exterior radii of the apex and the groove of the turn.

The interior radius in the turn groove Ric corresponds to the radius of the curved surface created at the exterior of the turn groove.

The interior radius at the turn apex Ris corresponds to the radius of the curved surface created at the interior of the turn apex.

Preferably, the mould and the core have a frusto-conical shape, their taper being defined by the angle γ between the straight line passing through two consecutive turn apexes and a straight line parallel to the axis of the bellows, passing through a turn apex. This angle is preferably greater than 1°, and can vary along the bellows.

Advantageously, it is specified that the taper of the mould is less than the taper of the core.

Considering such a frusto-conical shape, it is specified that the threading of the mould and the core is performed so that the moulding space has a thickness efn that increases as the diameter Dmn decreases.

According to another characteristic, the thickness of the moulding space at the level of the grooves ecn is greater than the thickness of the sides efn.

In addition, the mould and the core are defined so that the turns of the casing with bellows have a cross-section that decreases in a direction opposite the unmoulding direction. In other words, each helical turn has a geometry with a size smaller than or equal to that of the preceding helical turn in the screwing direction.

Moreover, the turns of the core 1 are defined so as to take into account the following criteria:
0.13 Dmn≦P≦0.3 Dmn
0.7 P≦Hm≦1.8 P.

It is also noted that the threadings of the core and the mould have a constant pitch.

According to an embodiment shown in FIG. 1, the sides of the turns of the threading of the core have a straight portion that is inclined with respect to a straight line perpendicular to the longitudinal axis of the mould with an angle greater than or equal to the helix angle as defined above.

According to the embodiment shown in FIG. 2, the turns of the casing with bellows have undulated sides including different portions with different shapes.

As seen in FIG. 2, two adjacent portions of the sides have tangents, forming an angle A2 smaller than 15° between them, which tangents form an angle A1, A3 greater than 20° with the longitudinal axis of the core (and the casing).

According to the embodiment shown in FIG. 3, the core has two helical threadings 1a, 1b, with the mould having corresponding turns.

It is noted that, in this case, the threadings 1a and 1b have a helix angle ranging between around 2.5° and around 15°.

According to another characteristic of the invention, the mould has means for holding the casing so as to maintain the unscrewing of the core.

According to the embodiment shown in FIG. 4b, these holding means include grooves 212 in the threading of the mould so as to form projecting edges such as those 31 shown on the casing 3 of FIG. 5, which grooves have a depth greater than or equal to 0.15 mm.

These grooves can, according to another possible embodiment, be made in the form of a discontinuous groove along the threading of the mould.

It is noted that the grooves are preferably distributed in the mould so that the corresponding projecting portions of the casing are obtained on the ridges of the bellows.

In addition, the mould and the core can be designed so that the turns of the casing obtained have the following characteristics:
Ric≧0.02 P, preferably 0.15≧Ric≧0.04 P;
Ris≦0.1 P, preferably Ris≦0.04 P.

It is advantageous to have a radius such as this in the turn groove so as to reduce the concentrations of stress without thereby limiting the slope necessary for the turn sides to have good turn performance during both pulling and compression. The turn groove shape is not necessarily circular; it can have an elliptical appearance with radii greater than or equal to 2% of the pitch of the turn.

As regards the radius at the turn ridge, the radius as defined is adequate for attenuating the concentrations of stress. This radius is preferably chosen so as to be smaller than that at the turn groove because the cross-section of the turn apex is larger than that of the turn groove, at constant thickness. In addition, it is appropriate to limit the overall dimensions of this hinge area. It is the relative movement of the turn sides that contributes to the allowable range of motion of the bellows.

FIGS. 5, 6 and 7 each show an application of the casing with bellows obtained according to the invention.

The invention can also be applied to cable guides, FIG. 5, intended to protect cables that go in vehicle car doors (or hatch doors) and ensure the imperviousness thereof.

The flexible portion consists of bellows with helical turns, 3, made of a thermoplastic elastomer. The bellows comprises small lugs 31, which serve to hold the turns inside the cavities of the mould during the unscrewing of the core for the unmoulding operation.

A second application relates to the insulation of pipes (FIG. 6). Pipes are sometimes insulated so that they do not receive or transmit vibrations. Some air intake pipes comprise areas with bellows for this purpose and are produced by blowing, along with the disadvantages that this type of process brings with it. It is advantageous to have helical turns on these pipes, which offer a better compromise between the flexibility desired for insulating the vibrations and the strength necessary for the geometry of the pipe. Indeed, the spiral forms a better continuity between the turns of the bellows. In addition, the thicknesses of the turns are well controlled with the injection method, and intermediate attachment lugs 35 can be moulded simultaneously. An elbow pipe can comprise bellows 3a, 3b on different axes, for example at each end. In this case, one core is used for each segment. So that the bellows of the pipe can be produced with the device according to the invention, it is stipulated that the largest inside diameter of the turn apex be smaller than or equal to the smallest size for passage of the attachment base 32 of the pipe, so that the core can be extracted during the unmoulding process.

Another application relates to bumpstops (FIG. 7) having a bellows-shaped structure 34. This specific shape makes it possible to obtain a spring effect and enables significant crushing pressure to be supported. It is preferable to have a helix angle between 5 and 15° for bumpstops. In addition, the protective skirt 33 makes it possible to protect the shock-absorber rod when it is in the deployment position. The stop 34 and the skirt 33 can be moulded together by single or double injection. The skirt can also be formed by helical bellows.

FIGS. 8 and 9 show a specific embodiment of the means for holding the core, and more specifically an end thereof, on the side of the driving mechanism.

According to this embodiment, these holding means include a part 80 that has a support intended to hold a cylindrical portion of the core 1.

This part is movable with respect to the core, between a position removed from it (FIG. 9) and a position for blocking the core in which the part 80 centres the core with respect to the cavities (not shown in FIGS. 8 and 9) of the mould.

The actuation of the part 80 is obtained by a cam system with an inclined ramp, including a lug 801, integral with the part 80, which lug is mounted so as to slide in a ramp 811 provided in a drive member 81. The ramp system serving to transmit the movement could also consist of an inclined rib with a roller or a pin or else another sliding-contact rib.

As shown, the ramp 811 is inclined so as to convert a translational movement of the member 81 into a translational movement of the part 80, perpendicular to that of the member 81.

As shown, when the member 81 is translated leftward in FIG. 8, the lug 801 slides in the ramp while following the slope thereof, which translates the part 80 upward and brings the latter against the core, which is then blocked and centred with respect to the mould.

The member 81 is driven in translation with a hydraulic actuator 82 integral with one of the ends of the member 81.

Conversely, when the member is translated rightward, the lug 801, following the slope of the ramp 811, drives the part 80, which moves the latter away from the core.

The device according to the invention, in one or the other of the alternatives thereof, or in a combination thereof, can be associated with other devices of the same type so as to constitute a multi-cavity unit, consisting of identical or non-identical cavities.

In such a unit, the means for centring and/or blocking the core are actuated with common actuation means.

To do this, a member 81, as shown in FIGS. 8 and 9, has a series of ramps 811, each intended to cooperate with a lug of a part 80, the production devices being arranged in line in correspondence with the parts 80.

In addition, a device for actuating the screwing/unscrewing of the cores is also provided so as to act simultaneously on a plurality of cores, for example using a rack (or a plurality of successive racks borne by a single member) extending along the casing production devices arranged in line.

According to one advantageous alternative of the invention, one of the means for holding 6 the core 1 includes another stationary or movable core 65 (FIG. 8).

An advantage of such a solution is that it reduces the length of the unscrewable core 1, which enables the unscrewing time, and therefore the cycle time, to be shortened.

Another advantage is that it promotes the unmoulding. Indeed, if a cylindrical or frusto-conical portion with a very small taper is required at the end of the bellows 9, without being capable of providing enough lugs 8 therein, for example so as to place an attaching clamp, then the unscrewing of the core 1 causes a twisting of this portion, which tends to distort it. Thus, it is suitable to design another core 65 specifically for this portion. This core is preferably removed after having begun the unscrewing of the core 1, in particular using a slide valve 66 actuated by an angle pin when opening the mould.

It is noted in FIG. 10 that the specific core 65 mentioned above can be inclined with respect to the core 1, for example at 90°, so as to form an elbow on a bellows, for a cable harness lining, for example (FIG. 6). During the unmoulding, the core 1 is removed in direction A, while the core 65 is moved in direction B.

Another advantageous solution consists of creating a pneumatic channel 62 opening out at the interface between the two cores.

Thus, venting via this channel 62 of the end piece 6, consisting of this other core 65, makes it possible to not cause a vacuum during the unscrewing of the core 1. To securely hold the casing 3 against the cavities 2 of the mould, compressed air is preferably injected through this channel 62.

The advantage is that an airtight seal is obtained by having this bellows portion at the end, which securely holds this other core by the shrinkage of the material. And the compressed air is thus forced to hold the casing against the cavities, which promotes the unmoulding. This air also contributes to the cooling of the material so as to rigidify it more quickly.

According to an alternative of the production method, the latter includes a step for injecting a fibre-reinforced material. In the case of bellows, it is then suitable to implement this alternative so as to orient the fibres in the direction of the helix, while facilitating the flow of material into the turn and ridge grooves during injection.

1. Device for producing, by moulding, a casing (3) having at least one helical bellows, of the type including a mould (2) consisting cavities and at least one core (1), each having a helical threading complementary to one another so as to define a moulding space, said device including means making it possible to cause a relative unscrewing of said casing (3) and said core (1) in order to carry out the unmoulding of said casing,
characterised in that it includes means for holding (51, 6) each of the ends of said core (1) during the moulding, said core (1) having a helix angle smaller than around 15°.

2. Device according to claim 1, characterised in that said threadings of said core (1) and said cavities of said mould (2) have a helix angle of between 2 and 7°.

3. Device according to one of claims 1 or 2, characterised in that said core (1) has a frusto-conical shape with a coning angle greater than or equal to 1°.

4. Device according to any of claims 1 to 3, characterised in that said threadings of said core (1) and said mould (2) are provided so that said moulding space has a cross-section that decreases in a direction opposite the unmoulding direction.

5. Device according to any of claims 1 to 4, characterised in that at least one turn of said threadings of said mould (2) and said core (1) has a pitch between around 10% and around 40% of the mean apparent diameter of said turn.

6. Device according to claim 5, characterised in that at least one turn of said threadings of said mould (2) and said core (1) has a pitch ranging between around 13% and around 30% of the mean apparent diameter of said turn.

7. Device according to any of claims 1 to 6, characterised in that at least one turn of said threadings of said mould (2) and said core (1) has a depth between around 0.5 times and around 3 times the pitch of said turn.

8. Device according to claim 7, characterised in that at least one turn of said threadings of said mould (2) and said core (1) has a depth between around 0.7 times and around 1.8 times the pitch of said turn.

9. Device according to any of claims 1 to 8, characterised in that said turn(s) of said threading of said mould (2) have a side including at least one straight portion inclined with respect to a straight line perpendicular to the longitudinal axis of said mould (2) with an angle greater than or equal to the helix angle of said turn(s).

10. Device according to any of claims 1 to 9, characterised in that at least one turn of said threading of said mould (2) has a side including at least two portions having different shapes.

11. Device according to claim 10, characterised in that said two portions of said side have, on either side of a common area, tangents forming an angle smaller than or equal to 15° between them, each of said tangents forming an angle of at least 20° with the longitudinal axis of said mould.

12. Device according to any of claims 1 to 11, characterised in that said threadings of said core (1) and said mould (2) have a constant pitch.

13. Device according to any one of claims 1 to 12, characterised in that said threadings of said core (1) and said mould (2) are provided so that said casing (3) has turns of which the thickness at the level of the grooves is greater than or equal to the thickness of the sides.

14. Device according to any of claims 1 to 13, characterised in that said threadings of said core (1) and said mould (2) are provided so that said casing (3) has a thickness that increases as the diameter of the cone frustum of said core (1) decreases.

15. Device according to any of claims 1 to 14, characterised in that said threadings of said core (1) and said mould (2) have, over at least a portion of their length, at least two helical threadings.

16. Device according to claim 15, characterised in that said helical threadings have a helix angle ranging between around 2.5° and 15°.

17. Device according to any of claims 1 to 16, characterised in that said mould (2) has means for holding said casing (3) on each side of the threading, during said relative unscrewing of said casing (3) and said core (2).

18. Device according to one of claims 1 to 17, characterised in that said threading of said mould (2) has means for holding said casing (3) during said relative unscrewing of said casing (3) and said core (2).

19. Device according to claim 18, characterised in that said holding means include at least one groove (212) intended to form a projecting edge (31) or a rib on said casing (3).

20. Device according to claim 1, characterised in that said means for holding the core include, at the end of said core extracted first from the mould during the unscrewing of the core, a cylindrical support (51, 7), and, at its other end, a frusto-conical support (6).

21. Device according to any of claims 3 to 20, characterised in that said mould (2) also has a frusto-conical shape the taper of which is less than that of said frusto-conical shape of said core (1).

22. Device according to any of claims 1 to 21, characterised in that said means for holding said core include means for centring said core with respect to said cavities.

23. Device according to claim 22, characterised in that said centring means include at least one housing capable of being moved toward/away from said core, said housing(s) forming means for centring and/or blocking said core in a specific position with respect to said cavities.

24. Device according to one of claims 22 or 23, characterised in that said centring and/or blocking means are actuated by a cam system with an inclined ramp.

25. Device according to claim 24, characterised in that said cam system with an inclined ramp is designed to convert a drive movement acting in a first direction with respect to said core, into a movement of displacement of said housing(s) in a second direction substantially perpendicular to said first direction.

26. Device according to any of claims 1 to 25, characterised in that said core is positioned so that it is offset with respect to said cavities, before injection, so that it tends to be re-centred in said cavities upon a thrust caused by an injection of material into said mould.

27. Device according to any of claims 1 to 26, characterised in that said holding means include at least one complementary core (65) in line with said core (1).

28. Device according to claim 27, characterised in that said complementary core (65) is inclined with respect to said core (1).

29. Device according to any one of claims 1 to 28, characterised in that it includes a channel (62) for injecting pressurized air between said core (1) and said casing (3).

30. Unit for production, by moulding, of casings including at least two devices of the type each including a mould (2) consisting cavities and at least one core (1) each having a helical threading complementary to one another so as to define a moulding space, said device including means making it possible to cause a relative unscrewing of said casing (3) and said core (1) in order to carry out the unmoulding of said casing, characterised in that said devices each have means for holding (51, 6) each of the ends of said core (1) during the moulding, said core (1) having a helix angle smaller than around 15°.

31. Production unit according to claim 30, characterised in that said means for holding each core include means for centring and/or blocking said core with respect to said cavities.

32. Production unit according to claim 31, characterised in that said means for holding said core of at least two of said devices are driven by common actuation means.

33. Method for producing a casing having at least one helical bellows, including a moulding step performed with a production device including a mould and at least one core each having a helical threading complementary to one another so as to define a moulding space, said device including means for causing a relative unscrewing of said casing and said core so as to carry out the unmoulding of said casing, characterised in that said moulding step is performed using a core with a helix angle smaller than around 15°, said core being held at each of its ends during said moulding step.

34. Method for producing a casing according to claim 33, characterised in that it includes a step of injecting fibre-reinforced material.
